(19) United States
(12) Patent Application Publication
(10) Pub. No.: US 2017/0296919 A1
(43) Pub. Date: Oct. 19, 2017

(54) GAMIFICATION OF CUSTOMER RELATIONSHIP MANAGEMENT (CRM) SYSTEMS, SALES, AND SUPPORT AND CONTINUOUSLY LEARNING SALES ANALYTICS WITH GAME ENGINE

(71) Applicant: Vince Scott Margiotta, Coppell, TX (US)

(72) Inventor: Vince Scott Margiotta, Coppell, TX (US)

(21) Appl. No.: 15/479,249

(22) Filed: Apr. 4, 2017

Related U.S. Application Data
(63) Continuation-in-part of application No. 13/731,341, filed on Dec. 31, 2012, now Pat. No. 8,585,408.
Application No. 13/731,341 is a continuation of application No. 13/244,242, filed on Sep. 23, 2011, now Pat. No. 8,342,845.
Application No. 13/244,242 is a continuation of application No. 11/423,995, filed on Jun. 14, 2006, now Pat. No. 8,047,848.
(60) Provisional application No. 62/396,781, filed on Sep. 19, 2016.
(60) Provisional application No. 60/690,043, filed on Jun. 14, 2005.

(51) Int. Cl. A63F 13/46; G09B 5/00; G09B 19/00; G06Q 10/06

(52) U.S. Cl. CPC A63F 13/46; G09B 5/00; G09B 19/00

(57) ABSTRACT

A system comprising a virtual environment; users, each associated with a client computer, are represented by avatars within the virtual environment. Data collected by the virtual environment from enterprise data systems pertaining to users' activities relating to each of the users' historical performance on business-related tasks, is attributed to each respective user's character or entity within the virtual environment and the users receive game-related incentives within the virtual environment based on the collected data.

### CROSS-REFERENCE TO RELATED APPLICATIONS

The present application claims the benefit of and priority to U.S. provisional patent application Ser. No. 62/396,781, titled “GAMIFICATION OF CUSTOMER RELATIONSHIP MANAGEMENT (CRM) SYSTEMS, SALES, AND SUPPORT AND CONTINUOUSLY LEARNING SALES ANALYTICS WITH GAME ENGINE” which was filed on Sep. 19, 2016, and is also a continuation-in-part of U.S. patent application Ser. No. 13/731,341 titled “METHOD AND SYSTEM FOR PROVIDING GAME-RELATED INCENTIVES TO SALES PROFESSIONALS IN A VIRTUAL ENVIRONMENT”, which was filed on Dec. 31, 2012, which is a continuation of U.S. patent application Ser. No. 13/244,242, titled “METHOD AND SYSTEM FOR PROVIDING INCENTIVES IN A BUSINESS ENVIRONMENT”, and filed on Sep. 23, 2011, now issued as U.S. Pat. No. 8,342,845 on Jan. 1, 2013, which is a continuation of U.S. patent application Ser. No. 11/423,995, titled “METHOD AND SYSTEM FOR PROVIDING INCENTIVES IN A BUSINESS ENVIRONMENT” and filed on Jun. 14, 2006, now issued as U.S. Pat. No. 8,047,848, on Nov. 1, 2011, which claims priority to U.S. provisional patent application Ser. No. 60/690,043, titled “METHOD OF COORDINATING AN INTERACTIVE COMPUTER GAME WITH BUSINESS PROCESSES, PEOPLE AND SYSTEMS”, filed on Jun. 14, 2005, the entire specification of each of which is incorporated herein by reference.

### BACKGROUND OF THE INVENTION

### Field of the Invention

The present invention relates to multi-player interactive computer games, methods, and apparatus for use in a performance management and learning environment to interact with business processes and systems, and more particularly to the systems, methods and procedures used to first train, then engage and motivate employees to perform at highest possible levels during the analysis of customer needs, and during the accurate recording of customer interactions thereby significantly increasing customer relationship performance which includes sales performance and customer service quality.

### Discussion of the State of the Art

A major issue in the area of both measuring sales and service performance and replacing inefficient or nonworking business processes at least partially stems from very poor use of and lack of sales and service representative enthusiasm for currently available customer relationship management (CRM) package offerings. In the multi-billion dollar CRM market there is an approximate 50% failure rate of CRM system implementations. The primary reason for this high failure rate is poor end user adoption. A root cause for this low adoption is that current CRM deployments are perceived by the users whose performance being assessed as tedious, demotivating, unrewarding, unambitious, trivial and disconnected from users and work teams (see FIG. 1).

Additional contributing factors include: 1) Poor familiarity of available, probably useful features by the workforce: Fewer than 27% of representatives use even 50% of an average CRM's functionality; 2) Which may stem from poor, haphazard, training both around the time of rollout and during orientation training of new employees: CRMs are deployed with random or informal sales process and with highly rushed representative training; 3) Lack of familiarity of CRM function and methods to quickly fulfill enterprise expectations lead to: Systems lack timely, accurate prospect/customer data, leading to greater reduced usage, which only magnifies this issue; 4) Without meaningful incentives and lacking CRM feature familiarity to rapidly get information entered: Representatives frequently record data outside of CRM system, never transcribing it; 5) Realizing that significant data has already been lost and that their attempts to use the CRM system has not increased their efficiency, possibly hindered it: Representatives believe there is only marginal value in reporting sales activities; 6) End result: Sales and marketing department leadership lack confidence in sales data entered which only serves to maintain confirm representatives' views and perpetuate the cycle.

Further, exacerbating the above, many sales people lack engagement during these CRM implementations. Their management and CRM providers have not determined a solution to consistently improve CRM system user adoption. As a result, the CRM industry has the lowest percentage of loyal U.S. customers compared to other software segments according to The Walker Loyalty Report for Software and Hardware.

Often, management purchases a CRM solution, yet the employees do not use it, or use it at a bare minimum and often only under direct pressure from management. Implementing a CRM solution costs a company many thousands of dollars, plus monthly service fees. Front-line sales people and contact center agents who are meant to benefit from CRM, blame management for choosing poorly designed CRM solutions; management blames front-line users for failing to enter data in a timely and accurate manner; and the company loses its projected sales and service improvements and ROI due to these problems.

There are multiple reasons that sales representatives and contact center agents struggle in this environment. They are expected to continuously improve their performance by spending hours of time entering loads of data into CRM applications that fail 50% of the time. They typically have had 3 jobs over the last 7 years, each time being subjected to dry, fast paced, often passive, training sessions that conclude with them having pages of notes but being unable to remember most of the content when confronted with the actual CRM product and user interface. They also may have witnessed several CRM product failure over the years, wasting valuable sales or support time and lowering their metrics results, while they are focused on doing what management has asked, so now they are wary and skeptical of any CRM tool. In fact, they resist CRM, enter the minimum amount of customer and sales activity data and secretly blame management for penalizing them and wasting their time.

Management is also in a tough spot. Because most sales and support employees resist entering accurate and timely data, management does not have true visibility into lead generation, sales funnels, and customer service performance. Management knows sales people don't like the system so they don't trust the data sales people enter, and therefore no one gets the desired value from their CRM. Management doesn't understand why all the money they spent is not helping adoption so they blame sales people for not doing their job. Further magnifying the issue, the CRM providers and system integrators are in the middle of this conflict. Providers now have bad reputations and the integrators become the scapegoat because they sold the application.

The problem with existing CRM and related human resource performance management applications is that they are perceived by the users being measured as tedious, demotivating, unrewarding, unambitious, trivial and disconnected vs. how they wish the application could be which would be invigorating, optimistic, productive, meaningful, social, and fun to use. Prior art related to performance management and CRM software has not significantly addressed these problems with training efficacy and user engagement, and instead, have predominantly focused on the efficiency of the of the hardware and software design. As a result, related prior art lacks interactivity among users, either during training or production use, appealing multi-dimensional graphics, engaging narrative, intrinsic rewards, meaningful social impact, playful competition among peers and augmented mixed, or virtual reality.

According to Sirius Decisions, a leading analytics market research firm, CRM and related sales analytics should “enable more effective, fact-based decision making and sales leadership should leverage sales analytics to complement their sales experience and judgement.” In the multi-billion dollar sales analytics market the greatest deficiency is the failure of current sales analytics systems to explain why an enterprise's sales performance is at a certain level and how an enterprise may improve performance. Several key problems associated with current sales analytics systems are preventing continuously improving sales performance. First, currently available sales analytics systems typically measure sales activities such as, but not limited to, quantity of sales appointments, number of proposals, value of proposals, and close ratios. These key performance indicators (KPIs) are relatively easy to measure with CRM sales force automation (SFA) systems like SALESFORCE.COM™, but unfortunately, these metrics are self-reported by sales reps and contact center agents. CRM/SFA adoption by reps has historically been a challenge and even when CRM systems are adopted by reps, data accuracy and data integrity has been a challenge. Second, the sales rep sales and service related data collected from a single CRM system represents a very small percentage of all relevant sales activities that likely contribute to a sales rep's success or failure. These CRM/SFA data if sourced from a single IT system, would not include the great majority of sales related activities available from the collective group of other deployed enterprise IT systems such as email, internet, smartphone GPS, phone usage, etc. Third, these commonly tracked KPI's are typically pre-determined by sales management or part of a canned software solution that is not typically customized for the unique sales environment of a particular enterprise. This would prevent sales leadership from garnering the best possible sales insight. Fourth, most analytics are sourced through Customer Relationship Management (CRM) systems which companies typically expect sales people to fully adopt and utilize. However, full user adoption by sales people of these CRM systems has proven difficult and elusive across the CRM software industry. Finally, current sales analytics systems do not have the cross-platform capability to “learn” and identify potentially new meaningful sales KPI's common to top performing sales reps. As a result, enterprises are seeking CRM applications that sales people want to use. Sales leaders also desire the capability to not only provide insight into why certain sales teams and sales people perform better (more effectively and more efficiently) than others, but also how to identify and leverage new, meaningful sales analytics in a timely manner to help continuously improve enterprise sales performance.

What is needed is a system that expands on the ideas of gamification cited above providing innovation related to expanded tracking of sales activity, analysis of the activity, sales and service representative training, and a continuously learning method of tuning gamified sales and service performance metrics. Such a gamified system may also be adapted to drive socially responsible directed donation where inter-donor competition whether those donors are individuals or corporate teams as well as token reward systems are used to drive greater employee engagement and charitable giving during a campaign.

### SUMMARY OF THE INVENTION

The term gamification has emerged to describe systems similar to aspects of the invention. Gamification has been discussed in the literature since about 2011:

“Following the success of the location-based service Foursquare, the idea of using game design elements in non-game contexts to motivate and increase user activity and retention has rapidly gained traction in interaction design and digital marketing. Under the moniker “gamification”, this idea is spawning an intense public debate as well as numerous Applications—ranging across productivity, finance, health, education, sustainability, as well as news and entertainment media. Several vendors now offer “gamification” as a software service layer of reward and reputation systems with points, badges, levels and leader boards.” (“From Game Design Elements to Gamefulness: Defining “Gamification””, Deterding, et al., MindTrek'11, Sep. 28-30, 2011, Tampere, Finland; available at http://dl.acm.org./citation.cfm?id=2181037.2181040&CFID=856921889&CFTOKEN=31635 140; hereinafter “Deterding”, §1, lines 1-10)

The concept of gamification is quite new. Google Trends shows clearly that the term was a neologism in 2010; the very first Google search for the word “gamification” occurred in January 2010.

Aspects of the invention are directed to the idea of, “gamification of a CRM application”, in the sense given in the above definition and the remainder of Deterding. For example, according to various aspects, the following elements are clearly “game design elements”: “representing . . . users [players in games]. . . as avatars . . . in a virtual environment”; “comparing performance of users against the performance of others”; “awarding game-related incentives”; “modifying avatars based on performance [e.g., character avatars change as players gain experience in games]”; and “providing information regarding the first user's achievements or incentives to at least a second user involved in activities related to the business-related tasks not associated with the virtual environment performed by the first user [e.g., leaderboards in games]”. These game design elements are applied in non-game contexts, by, “automatically collecting data via a network from a plurality of enterprise data systems comprising at least a customer relationship management (CRM) system and pertaining to one or more of the users' historical activities not associated with the virtual environment relating to each of the users' performance on business-related tasks within the enterprise”. That is, claim 1 and all of the other claims clearly claim something that later came to be known as “gamification”.

Gamification has become a major trend in the computer software industry, with all major vendors of enterprise software (for example) providing gamification as key features in their mainline products starting as early as 2012. Companies have been formed and have grown focused on gamification (for example, BUNCHBALL™). Finally, gamification was a new concept in 2008, yet applicant filed the parent application of this patent family on Jun. 14, 2006, claiming priority to a provisional patent application filed on Jun. 14, 2005. There is an important distinction between “providing game-related incentives to sales professionals” and “gamification of a CRM application”. The first would encompass use of non-computer-based games such as sales contests, which clearly existed in the pre-computer world for a long period. The second, however, is a new idea unique to the world that emerged when computer-based gaming became prominent. Gradually, starting with applicant's first patent filing in the instant family—in 2005—and proceeding as the industry adopted the concept from 2008-2012, computer gaming technologies and mechanics were applied to the gamification of real-world business processes and activities. The gamification of sales, for example, as the term is understood in the art, means the application of design elements from computer gaming to the improvement of sales processes. This is precisely what aspects of the invention are directed to, and it is not an impermissibly abstract idea under Alice.

To see this, consider why the claims in Alice were rejected as impermissibly abstract. Like Bilski, the claims in Alice were directed to a fundamental economic practice of long standing (mitigation of settlement risk in Alice; reduction of risk by using forecasts in Bilski), with the direction to in effect “apply it” on a generic computer or on the Internet. But gamification is not a fundamental economic practice of long standing; rather, it is a technological development by which elements of gaming technology and game design are incorporated into software application to improve their effectiveness in stimulating improved human performance in desired tasks. Gamification of an enterprise software application (for example, of SalesForce.com, which could benefit from use of applicant's invention), is a technical enhancement of a complex product of technology that achieves a measurable outcome that is desirable. You can't do gamification in your head, or on a pencil and paper. Holding a sales contest for a church fundraiser is not gamification (it is a game). Gamifying an application so that people have higher engagement with the application and, potentially, so they learn improved behaviors guided by the gamification elements, is a technical undertaking that was never contemplated before the invention.

The question of whether “gamification of a CRM application” is an impermissibly abstract idea is a straightforward one. Gamification of a CRM application involves modifying a large, complex software application by the introduction of elements taken from computer gaming, such as the use of avatars and leaderboards. For example, Oracle reported in 2012 that its UX (user experience) team was “busy—very busy—working on gamification of a few key enterprise flows” (“Moving gamification from concept to design”, Erica Webb, at https://blogs.oracle.com/Gamification/entry/moving_gamification_from_concept_to). And SALESFORCE.COM™, a leading CRM vendor, has in its marketplace an entire category of third party applications dedicated to gamification of various aspects of their CRM system (see https://appexchange.salesforce.com/collection/gamification). And Microsoft has an entire specialized website highlighting the technical improvements they have made to their CRM system by gamifying it (“Technology to help companies improve sales and services performance—Measure. Engage. Improve”, on home page of www.crmgamified.com). These are major software vendors making major technical changes to their CRM systems to gamify them, and each of them promotes their efforts as a significant breakthrough. Clearly gamification, which did not even exist as a word in 2007—two years after applicant's initial invention of the concept—has become a major force in enterprise software. It is not a fundamental economic practice of longstanding, as in Bilski and Alice, but a substantial technological invention that has swept the enterprise software world. That is, gamification is a technical improvement in large-scale enterprise CRM systems, and so it improves the working of specially-programmed computers.

Finally, as noted by an examiner in allowing a parent application, “an inventive concept is found in the non-conventional and non-generic arrangement of additional elements: namely the first user's performance not associated with the virtual environment is compared with others' performance in the game engine using data automatically collected from the customer relationship management system, awarding game-related incentives based on the comparison, and reflecting the award with the user's avatar when viewed as a whole with other limitations in the claims.

Sales activity tracking in this disclosure is expanded by incorporating “identity management” or “digital signatures” of sales reps. These digital signatures will provide an ability to track activities cross-platform including company email, internet use, business smartphone GPS, phone calls and more.

Analysis of these activities is also described specifically. Through a virtual economy established in the online game, top performer activities across all IT, Marketing and Communication systems will be identified and “top performers' top activities” will be sourced to identify activities in common, near real-time as a best practice.

Sales training is also described. Once a best practice is identified, an in-game message will be delivered to all players to encourage replication of best practice across other players if possible. Low performers identified through game, will be required to complete in-game “missions” involving activity based and/or skill development in order to proceed with gameplay.

A continuously learning aspect is also described. Sales analytics are used to identify best practices of top performers near real-time. Once a new best practice metric is identified by the system, an in-game business incentive is immediately created and players informed of the new best practice and related “virtual” rewards for replication of the best practice.

Finally, players may better engage in the sales process in a meaningful way by earning incentives in a virtual game economy that may be converted into real world directed monetary donations to charitable organizations. One embodiment of this would be accomplished through a virtual Charity Battle Arena. A player that has achieved a certain level of performance and incentives, could challenge another player to a competition in the Charity Battle Arena. Each player would be competing for each other's earned incentives and the right to make a directed donation to their favorite charity. Winning player would then convert the combined incentives of each player to a directed donation. In addition to player vs. player, teams of players could challenge other teams in a similar manner and winning team would make the collective donation of all incentives to a specified charity.

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a pie chart illustrating the most important factor for realizing software value (PRIOR ART).

FIG. 2 is a flow diagram of exemplary data recording, animation, and analytics logic flows according to an embodiment of the invention.

FIG. 3 is a flow diagram of exemplary data recording, animation, and analytics logic flows use in determining top performer according to an embodiment of the invention.

FIG. 4 is a block diagram illustrating an exemplary hardware architecture of a computing device used in various embodiments of the invention.

FIG. 5 is a block diagram illustrating an exemplary logical architecture for a client device, according to various embodiments of the invention.

FIG. 6 is a block diagram illustrating an exemplary architectural arrangement of clients, servers, and external services, according to various embodiments of the invention.

FIG. 7 is another block diagram illustrating an exemplary hardware architecture of a computing device used in various embodiments of the invention.

### DETAILED DESCRIPTION

The inventor has conceived, and reduced to practice, a system for gamification of customer relationship management systems, sales, and support and continuously learning sales analytics with game engine.

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring sequentially (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described, it will be readily apparent that more than one device or article may be used in place of a single device or article. Similarly, where more than one device or article is described, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be noted that particular embodiments include multiple iterations of a technique or multiple manifestations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

Program functions and capabilities are not always attributed to a named software set or library. This in no instance implies that such a specific program, program function, or code library is not employed but is meant to allow time progression based changes to be made. In all cases at least one open source or proprietary software package providing the attributed functional result may be available and known to those skilled in the art or the algorithm needed to accomplish the function determinable by those skilled in the art.

### Prior Art

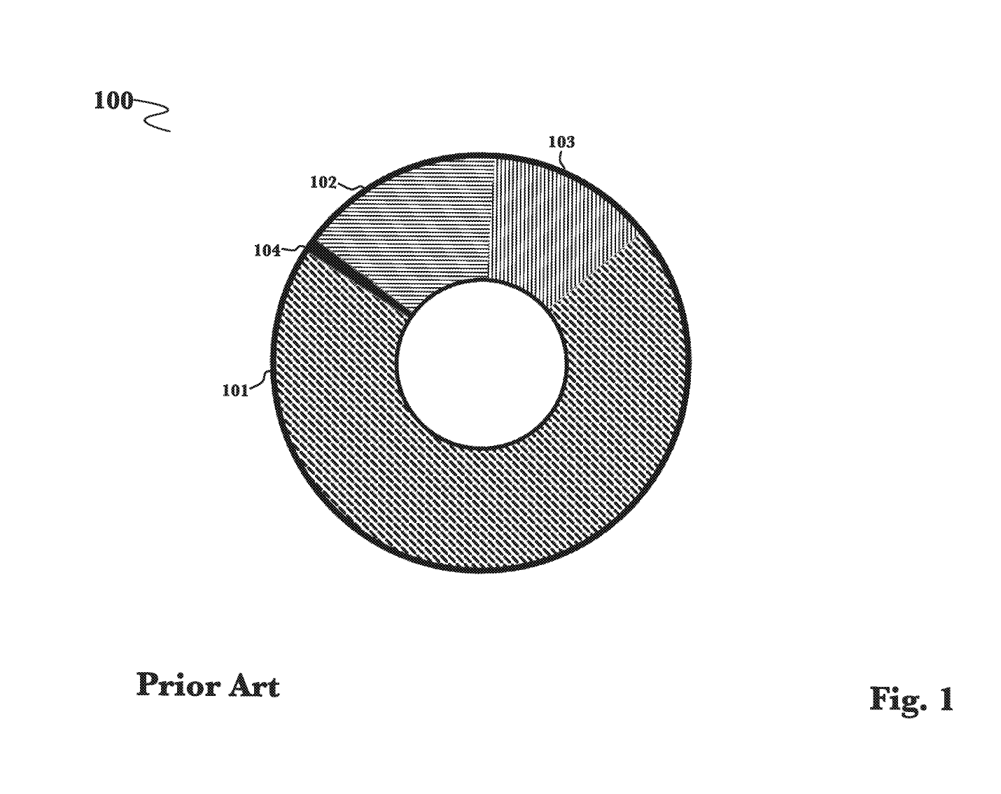

FIG. 1 is a pie chart illustrating 100 the most important factors for realizing software value (PRIOR ART). Taken from Defining Enterprise Software “Success,” SandHill.com and Neochange, 2008, this pie chart records the percentage of responses for four standardized answers to the question: “Most important factor for realizing enterprise software value?” The largest percentage of respondents (70%) answered “Effective user adoption” 101 as the most important factor while the second most important factor was cited as “Organizational change” (16%) 102 the very close third as “Process alignment” (13%) 103 and “Software functionality,” surprisingly, was chosen by only about 1% of respondents 104. This shows that, as proposed, user adoption, is by far the most important issue in business process software success.

### Conceptual Architecture

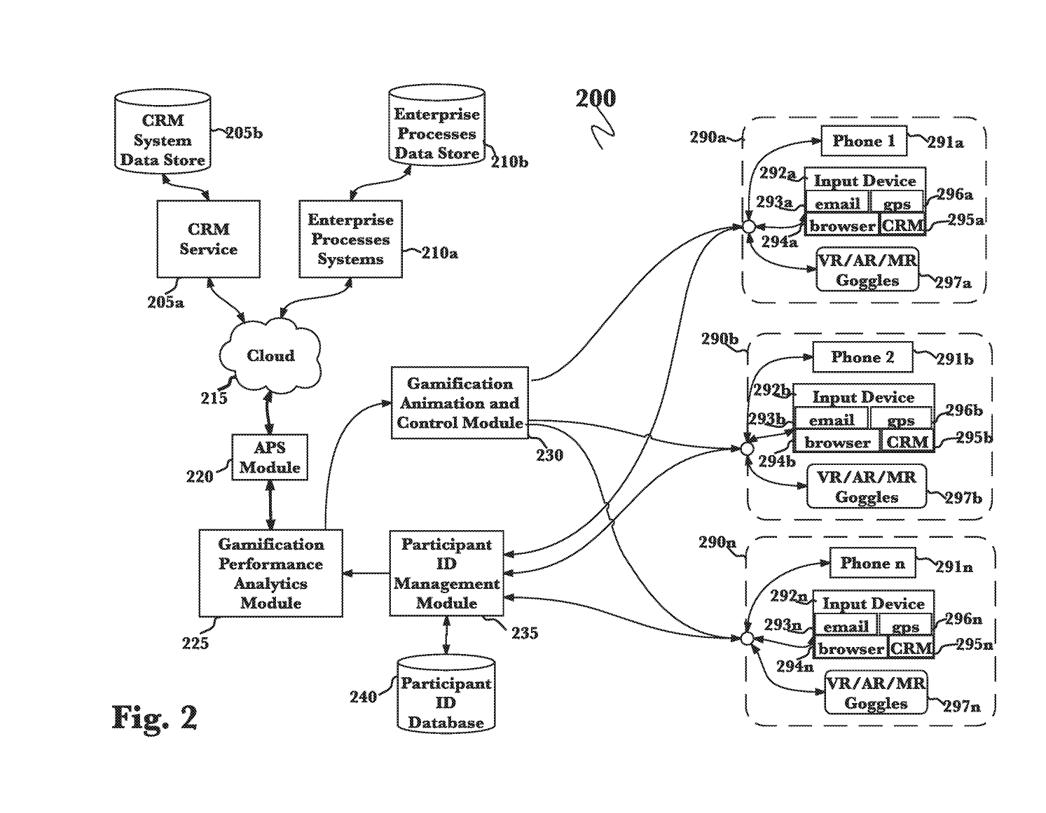

FIG. 2 is a system diagram 200 illustrating the sales analytics game engine environment according to an embodiment. In one aspect, sales representatives or contact center representatives (hereinafter the set comprising both sales representatives and contact center service representatives referred to as “representatives”) may enter sales and customer related data into their company's CRM 205a or WFM through their personal computer, smartphone or tablet to name a few example input devices 292a, 292b, 292n that may be used. The system's gamification performance analytics module 225 may then perform analytics on these entered data using predetermined company key performance indicators (KPIs) that may have been retrieved from storage connected to the company's enterprise processes systems 210a and related data stores 210b, which may use programming of an APS module 220 to communicate with those systems, to compute an achievement value for that representative. An achievement score, including among other things, a CRM usage and company process compliance value for each communication for each representative may be stored associated with the representative's participant ID 240 which is attached to each representative communication of any type such as but not limited voice, CRM or WFM system, email, social media, and chat, just to name a few communication types that may be used for this purpose known to those skilled in the art. Over time the gamification performance analytics module 225 may monitor each communication thread to measure predetermined factors such as number of customer interactions, interaction success, as measured by metrics such as sales closed or post-contact survey data among other possible metrics, assigning additional points or value to each representative's achievement score. Additional points may be given for specific, possibly novel combinations of compliant actions, or novel, imaginative nearly-compliant actions and non-compliant actions brought to management or team leadership attention through feedback mechanisms of the system which may be analytically found to lead to superior results, flagged and possibly used to improve existing processes. Additionally, each representative's real time instantaneous computed achievement score may be compared to sales or other work place goals in the gamification performance analytics module 225. Resulting “scores” may be used by the embodiment's gamification animation and control module 230 to convert each representative's (or teams of representatives') into game inputs that drive virtual competitions between representatives whether individually or in team groups, by extension driving real world competition to achieve advantage in the game in a fun and constructive manner. To present one of a plurality of examples available, the gamification animation and control module 230 may, modify each representative's or team of representatives' avatar within a VR game as well as related system-wide animation of reported badges, powers and game levels of each representative may be visibly modified to reflect success or lack of success the representative is having relative to other team representatives or relative to their management assigned goals and KPIs. Representatives may access virtual competition games via web browser interface 294a, 294b, 294n to gamification animation and control module 230 for simpler 2D games where they may immediately visualize the impact of their performance on their avatar, points, badges, etc. and compare their performance and avatar to others, collaborate with peers for advice and best practices and play virtual competitive games. Other possibilities for both 2D and 3D VR games is the use of VR/AR/MR goggles 297a, 297b, 297n where games may involve any one plurality of first or third party adventures where both representative and her colleagues participate. Managers may receive analytics from gamification performance analytics module which are used for motivation, analysis, coaching, team building and business process performance. Further, managers, senior management and others within the company with correct gamification animation and control module 230 access privileges may also observe players' performance via web browser connectivity or using VR goggles connected to the embodiment.

Another embodiment may run software configured to use gamification in a role of training both enterprise processes and CRM system usage tailored to the best practices of a company to both new hires, to teach and solidify use of those practices, and existing employees to either retain strong skills or for team building purposes. A new hire training aspect may use past or simplified sales, support or process cases retrieved from CRM service 205a, 205b or other enterprise processes systems 210a, 210b to create interactive animations, generated by programming of the gamification animation and control module 230, displaying the correct process for data entry and highlight the specific types of data that must be recorded in specific CRM fields (ex. Full contact company name must be entered in Field 2 and Field 20; The full name of contact person must be recorded first name in Field 3, last name in Field 4, full name in Field 20; all part numbers for components of a system sale must go in Field 15 and Field 20; or during a service call all technicians' names brought into the call must be recorded in Field 10 and Field 20; to give just a few simplistic, partial examples of the many possible). Trainees may then be drilled in correct use of CRM and enterprise process tools, encountering progressively complex cases in interesting gamified methods produced by the programming of the gamification and animation control module 230 such as but not limited to puzzles, playing cards or dice games where CRM customer call information are placed in the wrong fields and must be re-arranged to create a correct record, or call information must be dragged and dropped from a list or pile of information text outside of the CRM form. Other possibilities, which may be introduced once basic skills have been introduced and reviewed, may be VR races, foot, bicycle or car between new hires or a between anew hire and a computer-generated opponent where correctly entering training call information conveyed from such sources as, but not limited to voice, email, or chat in both new call record and call record update settings, leads to advancement in the game. Several other examples may of attention retaining gamified training methods may be known by those skilled in the art, examples given here are presented solely to illustrate aspect concepts while maintaining brevity and do not denote limitations in the capabilities of the invention. During the entire training period, programmed gamification performance analytics module programming 225 may be used to monitor and assess the progress made by each trainee and progress reports with predictive assessments of the strengths, weaknesses and under certain circumstances assessments for future, production, success of the trainee candidate, may be sent to management and team leadership at pre-designated periods to allow special attention to be given to weaker trainees, if desired. In the later stages of training, high levels of attention may be maintained by holding completion accuracy driven games between trainees.

Over time, even a well-trained, compliant workforce may lose some of its edge, shortcuts are found and spread, supplanting established best practices, and important process knowledge, not regularly used is forgotten. Teams of strong employees may also become islands, no longer performing as a team to solve difficult cases or to consult on forgotten knowledge, weakening the team. An aspect may be engineered to assist in these types of issues with existing sales and service employees using attention keeping gamification for increased impact. Games to either practice forgotten best practices or introduce changes to best practices may be configured to occur individually when the gamification performance analytics module 225 determines that a representative, who may be identified by her participant id 235, 240, has performed a task incorrectly from one to multiple times and may be presented in the form of a short, animated timed and scored game constructed by the gamification performance analytics module 225 and the gamification animation and control module 230 where the representative is reminded of the best practice then challenged to correct her error and then correctly identify and resolve similar, possibly fictitious errors to reinforce the forgotten practice. Introduction of best practice changes may be similarly individually introduced when a representative is determined to have begun an affected task by the gamification performance analytics module 225 to automatically place the change in the right mental context using a short game presented by the programming of the gamification animation and control module 230. The ability to postpone the review may be given to allow for ongoing, time sensitive customer tasks but completion of the review, meant to be as much entertainment as informative will need to be completed. Other methods to complete either best practice change introductions or best practice item review such as but not limited to a regular time set aside as part of the representatives' work schedules may also be available so none of the example scheduling possibilities should be seen to limit the capabilities of the invention. Another area of organizational strength that may suffer as sales representatives pursue busy travel schedules or work in isolated cubicles or service representatives work in cubicles is team cooperation to help raise all representatives to the highest possible level when confronted with complex or infrequent obstacles. Gamified teambuilding activities using an aspect may be undertaken from connected workstations anywhere in the world allowing them to occur without unduly affecting participant's ongoing work schedule activities and may maintain the workforce in place should a significant customer related issue arise. One such game might be an adventure type game where multiple team members are individually given game related information that must be combined at specific points of the game to move forward or prevent disaster. More than one team, for example sales vs. service may play the same game, with the team that cooperates the best potentially completing or “winning” the game. This arrangement between corporate members who may have some pre-existing, real-world sense of competition, may increase the level of competition and team identity. More tangible reminders of failure in strong team cooperation may be injected into the game by injecting pre-game analytics calculated teamwork scores into the game.

Another embodiment may allow representatives or teams of representatives, playing for donations to their favorite charity, to challenge other representatives or teams of representatives playing for their favorite charity, in a set of multiple virtual games 230 which may or may not be based upon facets of business related proficiency 225, similar in format to the Olympics, a Charity Battle Arena or World Championship Games and where the achievement points 235, 225, converted to a monetary value, of both participants are donated to the winners' charity. Such games may be repeated at the discretion of management for example on specific days quarterly, semi-annually, or annually and may be more widely broadcast to the corporation of status board displays, workstations, or other display vehicles familiar to those skilled in the art. Under certain aspects, to drive up anticipation participation interest and excitement, employees not directly involved in the competition may be given the opportunity to use their achievement points to back one of the participating individuals or teams with the virtual arena displaying banner like advertisements for the chosen charities with backing counts incorporated. The main goals of the endeavor being social awareness and increased company-wide cohesiveness.

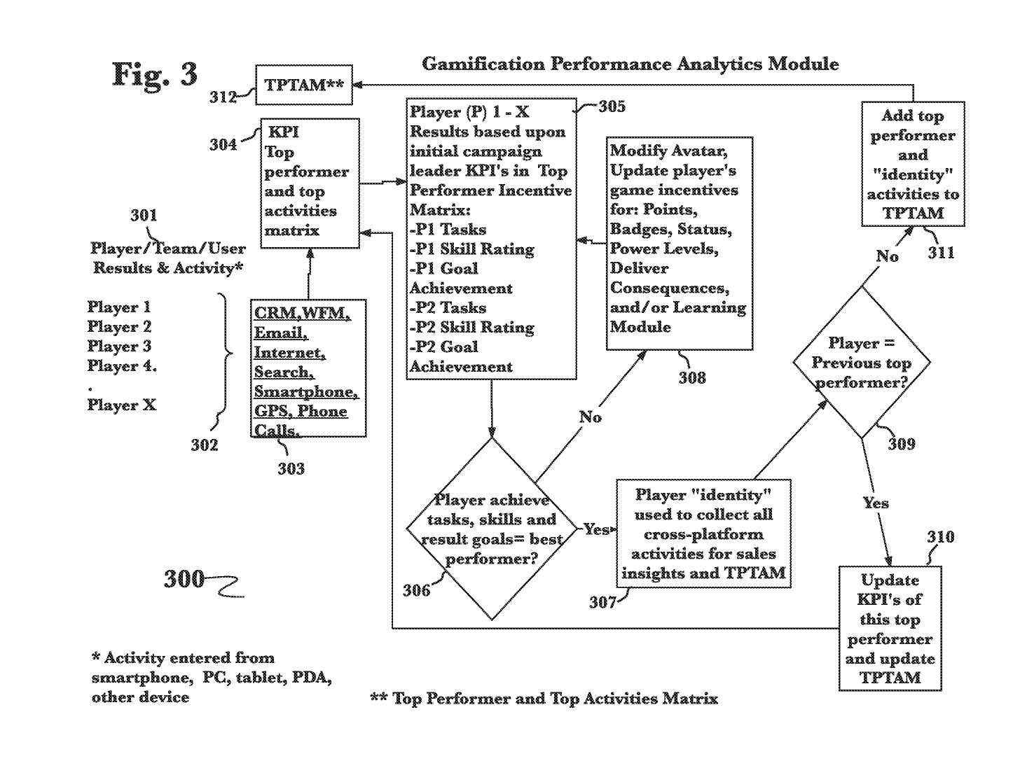

FIG. 3 is a flow diagram 300 of exemplary data recording, animation, and analytics logic flows use in determining top performer according to an embodiment of the invention. Ongoing activity results such as CRM or WFM information entry proficiency per email, chat, social media, and smartphone call among other possible scorable parameters 303, representing a predetermined granularity: “player”; “team”; or “user” 301, illustrated here as individual players 302 and scored by the gamification performance analytics module (see FIG. 2, 225) are entered into a running matrix which may measure an enterprises KPI level goals 304. This matrix may be unobtrusively displayed for all involved parties showing rank and each parameter score of each participant (“player” here) to drive overall completion based excellence and task specific improvement 305 or it may be used as part of an ongoing game or ongoing game leader board 306 with the parameter scores affecting the player's avatar in that game 307 depending on her score in ongoing competition 308. Special recognition may be given under such circumstances as being repeat top performer 309, with new top performer levels being published 310 and new top performer's name replacing the old top performer on a status display or the leader board 311, 312.

In contrast to existing CRM deployments and related prior art, described embodiments provide an engaging application that sales and service people want to use because it provides entertaining multi-dimensional animation, game based narrative, intrinsic rewards, and playful competition while helping improve their performance at work. The embodiment is an animated, visually multi-dimensional, human resource management apparatus that effectuates an engaging game-based virtual/augmented environment, format and business operation to create, digitize and animate images representing real-life sales and service metrics and human resource performance near real-time; visible on users' 2 dimensional (2D), 3 dimensional (3D), or other high definition (HD) pixelated computing or mobile devices comprising: creation of an avatar, animated persona or graphical indicia representing users, who are typically individual salespeople, contact center agents or workers, or teams of salespeople, call center agents or workers, as players in a computerized, virtual game-based operation; automatically collecting common and user specific real-life sales, service or work related performance data and pertaining to one or more users' activities not associated with the virtual environment via a network of enterprise data systems comprising at least a customer relationship management (CRM) system or enterprise workforce management (WFM) system; pre-establishing sales, service or work related goals for the users or teams of users and storing the sales or work related goals in computerized memory coupled to processor; upon users' real-life sales or work related activity executed and stored in CRM or WFM, simultaneously computing users' or team of users' real-life historical performance of sales and work related tasks stored in computerized memory coupled to processor and game-based software; computed as a value to determine relative performance of at least a first user or team of users compared to sales or work related goals; comparing near real-time actual computed values of at least first user's or team of users' performance to a set of other users or teams of users' participating in game-based operation, performances of similar sales or work related tasks input into those users' comparable user specific data fields in CRM or enterprise WFM; ranking and scoring users or teams of users based on performance relative to pre-established goals and relative to other users' or teams of users' performances; awarding points, badges, computer game player-related powers, ranking and incentives based on degree of attainment relative to goal achievement and relative to user's or team of users' performances; creating digitized performance images in game-based virtual environment reflecting user's or teams of users' achievements relative to goals and relative to other users' or teams of users' performances; simultaneously processing computed values and digitized performance images in game-based virtual environment based on the users' or teams of users' performance results and advancing users' avatars, animated persona or graphical indicia in computer game operation; transforming computed values and digitized performance images into animated game-based format reflecting user's or teams of users' earned points, badges, achievements, game-based powers, status, ranking and incentives of users; displaying animated performance images of users' or team of users' performance, including points, badges, status, ranking, incentives and progress as players in computer game to plurality of users' 2D, 3D or HD computer imaging devices via a network for competitive, instructional and motivational effects on users; providing near real- time, digitized and animated performance imaging and visualization allowing superior comprehension of real-life performance and improving actual real-life performance for a plurality of participating salespeople, call center analysts or workers or teams of salespeople, call center analysts or workers, including their specific real-life performance related activities and their relative goal attainment thereby improving sales, service and human resource management technologies that historically provide performance results via generic computer generated spreadsheets, manual leaderboards, and CRM or WFM dashboards.

Moreover, the above embodiments describe a continuously learning, Sales Analytics Game Engine, that more broadly collects data from numerous enterprise data systems, improves the quality of data captured and gamifies the entire enterprise metrics system to make it more employee engaging. Salespeople and call center agents will want to use the system because it provides individual participants “identity management” and tracking of sales or service analytics across multiple enterprise technology platforms delivered through an engaging video game-like, user interface that incorporates game mechanics including game-based narrative, intrinsic rewards, and playful competition among peers. Aspects provide continuously improving, near-real time analytics enhanced by a game engine animated user interface that maybe used to identify frequently changing top performers, their common enterprise activities identified across enterprise systems, best practices and training opportunities. Aspects maintain high levels of interest and performance excellence by awarding points, badges, computer game player-related powers, ranking and incentives based on degree of attainment relative to goal achievement and relative to user's or team of users' performances; training creating digitized performance images in game-based virtual environment reflecting user's or teams of users' achievements relative to goals and relative to other users' or teams of users' performances; simultaneously processing computed values and digitized performance images in game-based virtual environment based on the users' or teams of users' performance results and advancing users' avatars, animated persona or graphical indicia in the computer game operation, or electronically delivering a recommended training module to lower-performing players; transforming computed values and digitized performance images into animated game-based format reflecting user's or teams of users' earned points, badges, achievements, game-based powers, status, ranking and incentives of users; displaying animated performance images of users' or team of users' performance, including points, badges, status, ranking, incentives and progress as players in computer game to plurality of users' 2D, 3D or HD computer imaging devices via a network for competitive, instructional and motivational effects on users; providing near real-time, digitized and animated performance imaging and visualization allowing superior comprehension of real-life performance and improving actual real-life performance for a plurality of participating salespeople, call center agents or workers or teams of salespeople, call center analysts or workers, including broadcasting to all players the top performing players' specific real-life performance and their relative goal attainment; thereby improving sales and human resource management with highly engaging animated technologies, and playful competition that is invigorating, optimistic, productive, meaningful, social, compared to historical methods and prior art that provides performance results via generic computer generated spreadsheets, manual leaderboards, and dashboards which are perceived by users as tedious, demotivating, unrewarding, unambitious, trivial and disconnected from users.

The improved user adoption of the CRM system will enhance the sales analytics capabilities of the Sales Analytics Game Engine (SAGE) as more sales people use CRM more often and more comprehensively resulting in better data capture, data quality and data integrity. Enterprises typically establish sales KPI's to measure and compensate sales performance by periods of months, quarters, etc. Often, sales leadership will seek to measure and model top performers in CRM over these periods of time to gain insight on sales patterns of success and then develop best practices based on these insights. The SAGE system would “continuously learn” providing enterprises with the sales analytics measurements initially desired by sales leadership, but also provide sales leadership with additional, highly relevant sales KPI's derived from top performer activities across all “identity managed” enterprise technology platforms, not just their CRM system.

By way of example, a company may decide it wants to track the top 20 performers of their 100 person total sales force. Initially, sales leadership may have insight from their CRM systems and personal observations to create typical KPI's like number of cold calls, appointments, dollar value and quantity of proposals delivered, etc. These data today, may typically be tracked and reported in CRM monthly and could be used as metrics. Uniquely, SAGE will be capable of not only identifying top performers, based on CRM sales KPI provided, but also capture these top performers' activities across multiple enterprise systems including email, internet, electronic calendars, smartphone GPS, phone calls, etc. through identity management. These additional top performer insights from SAGE will provide enterprise system-wide top performer analytics for potential best practice (e.g. new and different sales and service KPI's) consideration by sales leadership or service leadership, not available from CRM alone. In addition, sales organizations are dynamic and rarely are the top performers daily, weekly, monthly the same top performers every sales period. SAGE will identify and capture the most current cross-platform sales analytics of the most current top performers allowing continuous learning and timely performance animation.

One embodiment may include an add-on, web-enabled sales force gamification application that automatically integrates with SALESFORCE.COM™ CRM through an Application Program Interface (API). Players, and their support teams may interface through computers, smartphones, etc. for example, to a massively multi-user online game where they develop and choose between various futuristic strategies to create a sustainable food supply that will help solve world hunger. A virtual economy is created for players by assigning points, game keys, badges, etc. for achieving real world sales or service related activity and sales or service results. Earned points, game keys and badges maybe used by participants to spend virtual game time and collaborate with peers to prevent the earth's demise and world hunger. Within the game, players may explore, use points to buy goods, perform virtual work or travel across the solar system to challenge other players who are competing for the same limited resources for the benefit of their own planets (e.g. team).

In this embodiment, sales and service activities would typically be entered into a CRM system such as the SALESFORCE.COM™ CRM system as “objects” (e.g. prospect or customer sales and service account related data) which are stored in the CRM database. This accumulation of this type of data by all sales or service representatives would be transmitted from the CRM database to the CRM parameters processor where the data are compared to established KPI's (e.g. goals) and scored based on their relative success attainment. The scored data for each representative may then be transmitted to the game engine where the results may be transformed into various forms of animated recognition and virtual incentives including enhanced avatar status, elevated game level attainment and virtual powers. Avatars, which represent players in the game, are also advanced in the game relative to peers, based on the scored data from real life activities and results.

Further incentive and user engagement is provided by allowing the very highest performers to use their virtual economy incentives for directed donations to real world charities. In this particular embodiment, donations would be related to world hunger, but any charity could ultimately be selected by a player or company. Expectations are that many prospective client companies have already designated certain socially responsible programs and flexibility to support these charities through gamified applications would be supported.

The fun and engaging aspects of this gamified process will enhance the quantity and quality of both sales and service data and analytics as more representatives participate and more accurately record their activities in CRM. A unique and valuable feature of this gamified solution is its ability to identify top performers based on their virtual economy earnings, near real-time. For sales, organizations may often wait until end-of-month or a longer sales period to identify and rank sales representatives. In this embodiment, top performers and their specific activities are tracked and reported near real-time. In addition, the analytics function will provide statistics and identify patterns of success based on top performer activities. These activities may be self-reported in CRM or through “identity management” and “digital signatures,” captured across all company IT, communication and marketing systems including email, Internet, smartphone GPS, phone calls, etc. Tracking these cross-platform activities also provides a continuous learning loop as the sales analytics game engine will continuously update and change a metric selection table (Top Performer's Top Activities Matrix) used to identify potentially new metrics common to top performers. Once any particular sales activity, not already a KPI, is identified cross-platform and reaches a thresh-hold of commonality across top performing sales reps, that activity may become a new KPI and assigned points, levels, etc. to encourage as a best practice. Again, this capability is provided near real-time, continuously.

This near real-time insight into sales KPI's and performance also allows the system to deliver just-in-time training and related education. For example, once a new pattern of success by top performers is identified, a system-wide message may be sent to all players to inform them that a certain best practice is common to the most current top performers and should be considered and replicated if possible. The analytics and game will also identify lower performers and deliver suggestions for improvement in some cases, or require them to a complete an in game “mission” where they must complete specific training related activities in order to further participate in the online game.

In various embodiments, functionality for implementing systems or methods of the present invention may be distributed among any number of client and/or server components. For example, various software modules may be implemented for performing various functions in connection with the present invention, and such modules may be variously implemented to run on server and/or client.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

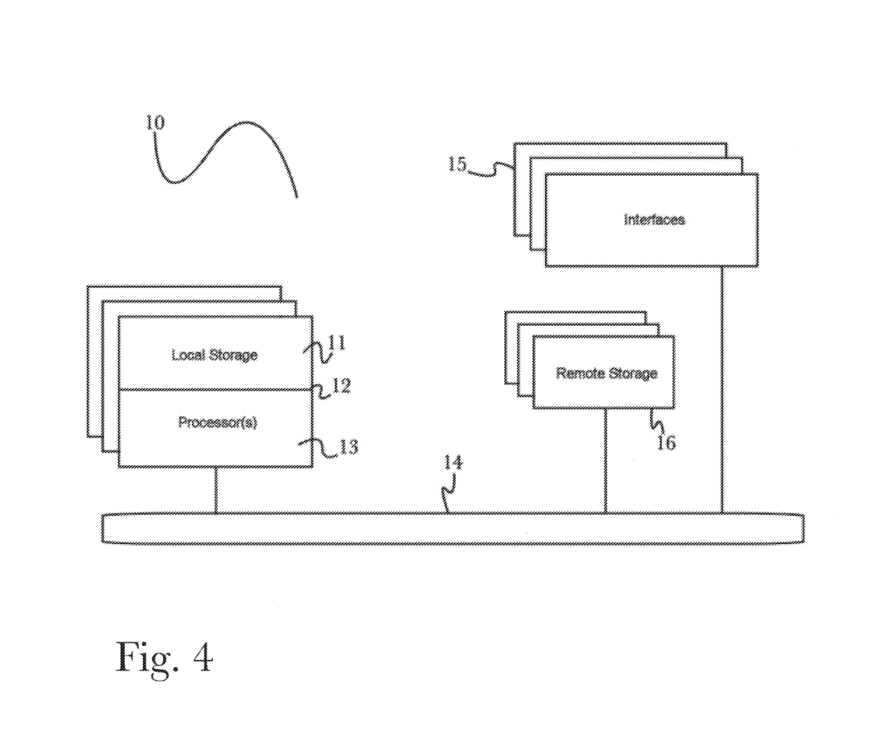

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown and described above illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include no transitory machine-readable storage media, which, for example, may be configured or designed to store program instructions, state information, and the like for performing various operations described herein. Examples of such nontransitory machine- readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

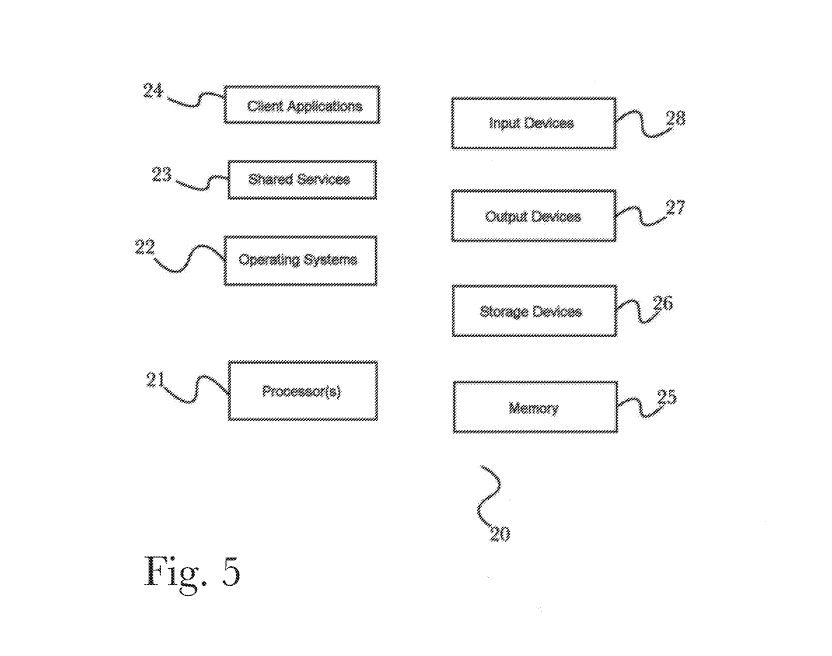

In some embodiments, systems according to the present invention may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above). Examples of storage devices 26 include flash memory, magnetic hard drive, CD-ROM, and/or the like.

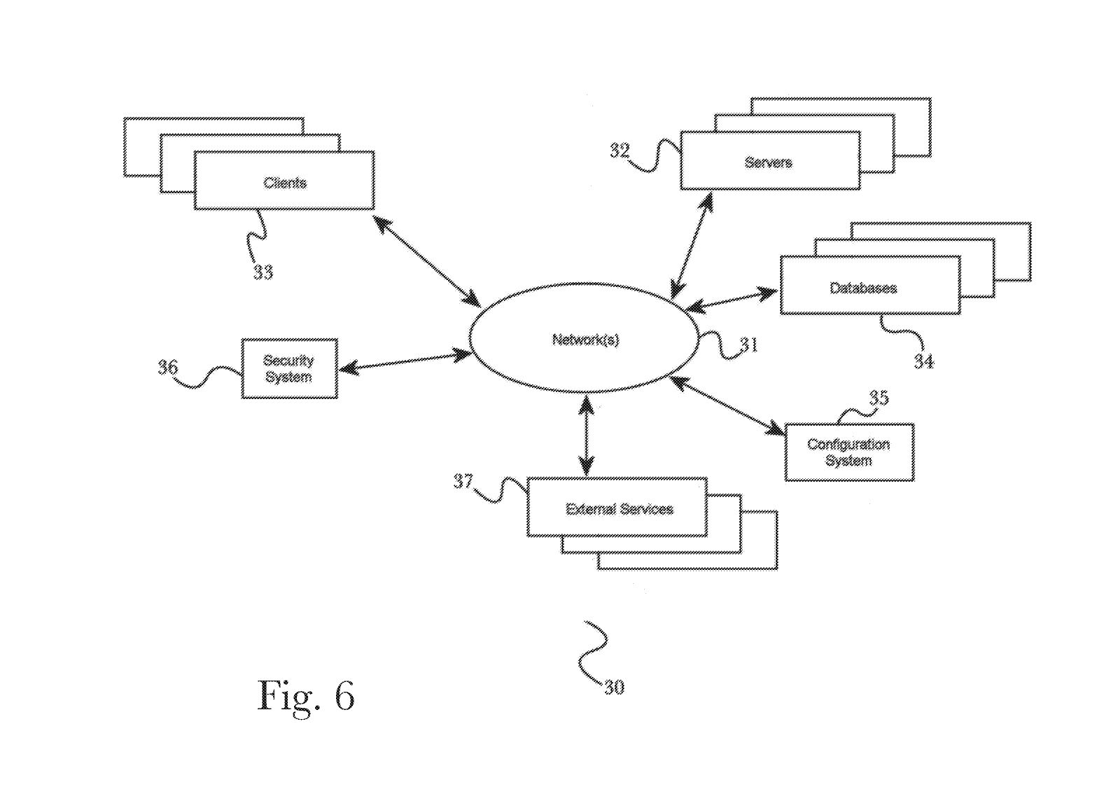

In some embodiments, systems of the present invention may be implemented on a distributed computing network, such as one having any number of clients and/or servers. Referring now to FIG. 6, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated above. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

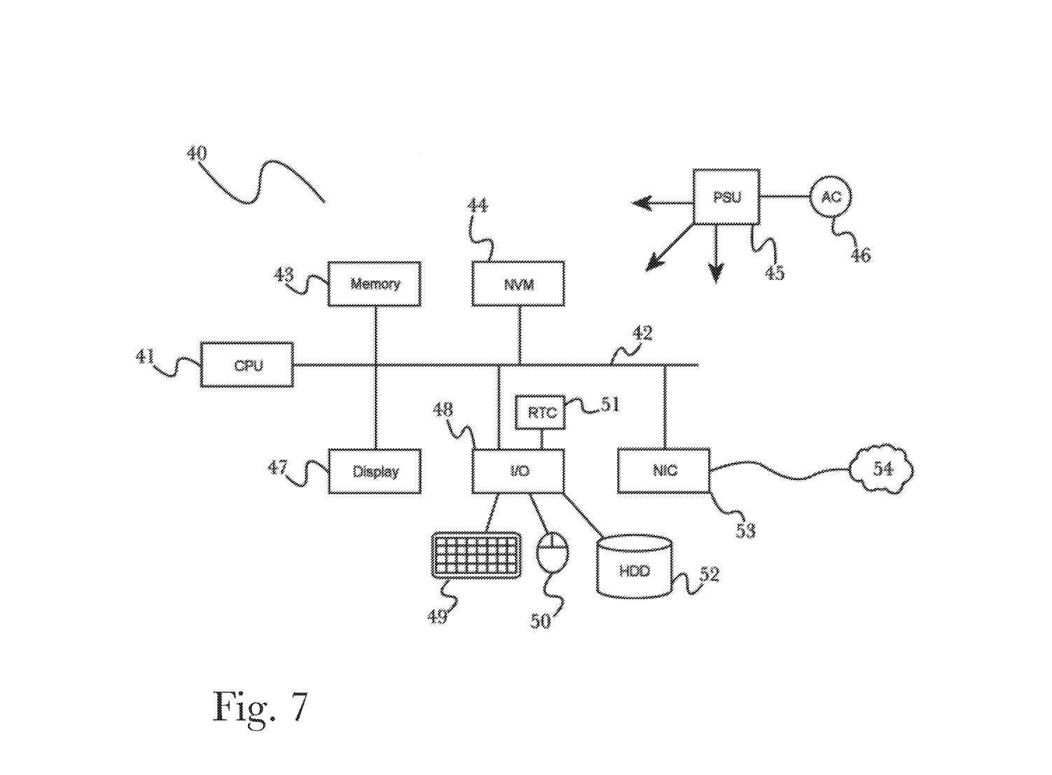

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example QUALCOMM™ or SAMSUNG™ system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

The skilled person will be aware of a range of possible modifications of the various embodiments described above. Accordingly, the present invention is defined by the claims and their equivalents.

1. A method comprising:
representing, using a gamification animation and control module, a first user of a virtual environment within an enterprise using a first avatar within the virtual environment;
receiving data via a network, the data comprising at least customer relationship management information from a plurality of external business data sources communicating via the network;
attributing at least a portion of the received data to the first avatar;
comparing at least the portion of the received data attributed to the first avatar against at least a portion of the data attributed to a plurality of other avatars;
assigning a value to the first avatar based at least in part on the comparison;
providing a plurality of game-related incentives to the first user the incentives being based at least in part on the value;
modifying the first avatar within the virtual environment based on the game-related incentives awarded to the first user;
providing information regarding the first user's game-related incentives to a plurality of other users, the other users being associated with the plurality of other avatars; and
storing at least a portion of the received data for future reference.

2. The method of claim 1, wherein the comparison involves historical data pertaining to a plurality of additional users.

3. The method of claim 1, wherein the comparison involves real-time data pertaining to a plurality of additional users.

4. The method of claim 1 wherein the comparison involves a comparison of the first user's current real-time data against at least a portion the first user's historical data.

5. The method of claim 4 wherein the incentives are configured to encourage the first user to improve their current performance relative to the stored historical data used in the comparison.

6. The method of claim 1, wherein at least a portion of the incentives comprise a virtual currency.

7. The method of claim 6, wherein the gamification animation and control module is further configured to allow a user to exchange at least a portion of their virtual currency for a charitable donation made on their behalf by the enterprise, the amount of the donation being based at least in part on the amount of virtual currency exchanged.

8. A system comprising:
a gamification animation and control module comprising:
a processor;
a memory;
a plurality of programming instructions stored in the memory and operating on the processor;
wherein, upon executing the programming instructions, the processor:
operates a virtual environment wherein human users are represented using virtual avatars;
receives data via a network, the data comprising at least CRM information from a plurality of external business data sources communicating via the network;
attributes at least a portion of the received data to a first avatar;
compares the data attributed to the first avatar against at least a portion of a plurality of data attributed to other avatars; and
provides a plurality of game-related incentives to the first user, the incentives based at least in part on the comparison;
modifies the first avatar within the virtual environment based on the game-related incentives awarded to the first user;
provides information regarding the first user's game-related incentives to a plurality of other users, the other users being associated with the plurality of other avatars; and
storing at least a portion of the received data for future reference.

9. The system of claim 8 wherein the comparison involves historical data pertaining to a plurality of additional users.

10. The system of claim 8, wherein the comparison involves real-time data pertaining to a plurality of additional users.

11. The system of claim 8, wherein the comparison involves a comparison of the first user's current real-time data against at least a portion the first user's historical data.

12. The system of claim, 11 wherein the incentives are configured to encourage the first user to improve their current performance relative to the stored historical data used in the comparison.

13. The system of claim 8, wherein at least a portion of the incentives comprise a virtual currency.

14. The system of claim 13, wherein the gamification animation and control module is further configured to allow a user to exchange at least a portion of their virtual currency for a charitable donation made on their behalf by the enterprise, the amount of the donation being based at least in part on the amount of virtual currency exchanged.

15. (canceled)
